(19) United States
(12) Patent Application Publication
(10) Pub. No.: US 2008/0239109 A1
(43) Pub. Date: Oct. 2, 2008

(54) Method and apparatus for correcting image distortion

(76) Inventor: David John Jennings, Edina, MN (US)

Correspondence Address: MERCHANT & GOULD PC, P.O. BOX 2903, MINNEAPOLIS, MN, 55402-0903, US

(21) Appl. No.: 12/075,491

(22) Filed: Mar. 12, 2008

Related U.S. Application Data
(60) Provisional application No. 60/909,442, filed on Mar. 31, 2007.

(51) Int. Cl. H04N 5/217; G06K 9/40; G06Q 30/00

(52) U.S. Cl. 348/241; 382/275; 705/14; 348/E05.024

(57) ABSTRACT

A method by means of mathematical mapping to remove distortions due to a camera lens, distortions due to image placement relative to the camera, and distortions due to affixing images on curved surfaces is disclosed. The invention provides a method for creating a mapping which, when applied to graphics or other images, will compensate for the effect of camera distortions and camera point of view, allowing the image to appear undistorted when viewed from the camera.

### CROSS REFERENCE TO RELATED APPLICATIONS

The present invention claims priority to Provisional Application Ser. No. 60/909,442, filed Mar. 31, 2007, and incorporated herein in its entirety.

### FIELD OF THE INVENTION

The present disclosure relates to an apparatus and method for correcting image distortion.

### BACKGROUND OF THE INVENTION

Images can appear distorted for a number of different reasons. For example, the orientation of the viewer relative to a display surface (projection surface), the contours of a display surface, the orientation of a display surface relative to a camera or projector, the orientation of the lens through which the image is captured relative to the physical object being recorded, and the refractive property of the lens through which the image is captured or projected are just a few common causes of image distortion.

A number of different techniques have been developed to correct for image distortion. For example, U.S. Pat. No. 5,319,744 to Kelly et al. discloses a system that corrects image distortion when an image is projected onto a curved surface and U.S. Pat. No. 6,462,769 to Trowbridge et al. discloses a method for correcting for point of view image distortion. The present disclosure provides a novel method and apparatus for correcting for distortion.

### SUMMARY

One embodiment of the present disclosure provides a method of correcting the distortions due to the characteristics of the camera lens and distortions due to orientation of the camera relative to the physical image being recorded. The method involves reconfiguring a physical image to compensate for the anticipated distortion. A specific embodiment of the present disclosure involves providing reconfigured graphics, corporate logos, advertising, or other images that appear undistorted when placed on a particular target location relative to a camera.

### BRIEF DESCRIPTION OF THE DRAWING

FIG. 1A illustrates a reference grid for mapping;

FIG. 1B illustrates the step of positioning this grid at a desired orientation relative to a camera;

FIG. 1C illustrates the grid distorted appearance from the viewpoint of the camera;

FIG. 2A shows an example logo as it appears without distortion;

FIG. 2B shows a reconfigured logo that is shaped to compensate for an anticipated distortion;

FIG. 2C shows the reconfigured logo orientated relative to a camera;

FIG. 2D shows the reconfigured logo displayed via the camera as the corrected image of the logo;

FIG. 3A is a top view of a camera mounted to a roof of a vehicle with graphics mounted adjacent to the camera;

FIG. 3B is a side elevation view of a camera mounted to a roof of a vehicle with graphics mounted adjacent to the camera;

FIG. 4 is a flow diagram that describes the process for correcting distortion according to an embodiment of the present disclosure;

FIG. 5A shows a first orientation of the camera relative to a physical image, wherein the physical image is aligned with the camera;

FIG. 5B shows a second orientation of the camera relative to a physical image, wherein the physical image is positioned approximately perpendicular to the camera;

FIG. 5C shows a third orientation of the camera relative to a physical image, wherein the physical image is angled towards the camera; and

FIG. 5D shows a fourth orientation of the camera relative to a physical image, wherein the physical image is angled away from the camera.

### DETAILED DESCRIPTION OF THE INVENTION

Methods for displaying graphics, corporate logos, or other advertising via camera have been used in various applications. In the prior art these graphics have been affixed to surfaces in the field of view of the camera. The graphics used for these applications have been standard images that are best viewed when directly in front of the image. When these graphics are placed on surfaces not directly facing the camera or on curved surfaces, the resulting image as seen through the camera is a distorted image. This distortion is compounded when the camera used to capture the image has a small focal length lens (wide angle lens) and when the surface is curved and slopes away from the camera. In some cases, the graphics are so distorted that they become unrecognizable.

One environment where the distortion due to relative image location and a small focal length lens is evidenced is with onboard cameras used in a number of televised sporting events, for example, auto racing. The onboard cameras are used to provide a view of the race from the perspective of the moving vehicle. Sponsors desire that their logos be part of the displayed view; therefore, logos are often positioned on the vehicle in the field of view of the camera.

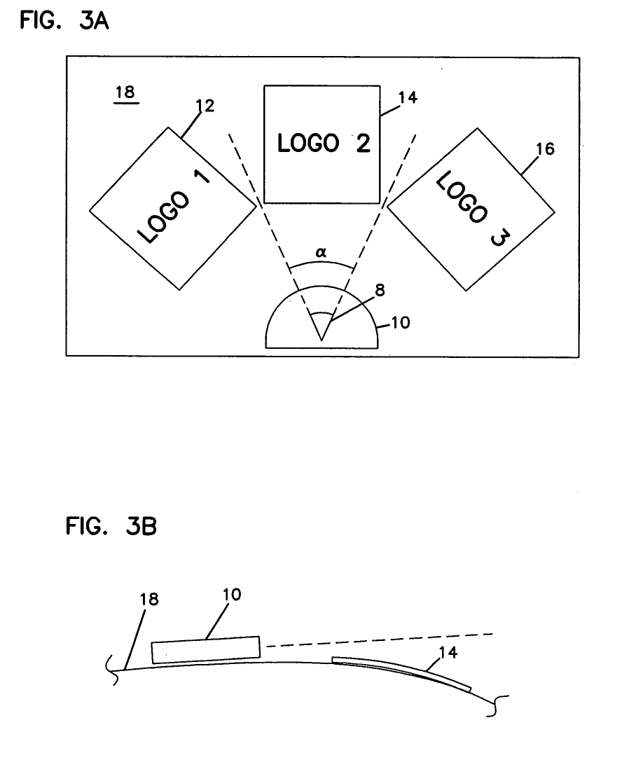

Referring to FIG. 3A, a top view of camera 10 with a pivotable wide-angle lens 8 arranged adjacent to three corporate logos 12, 14, and 16 positioned on the roof 18 of a vehicle is shown. In the depicted embodiment, the logos are affixed to the roof 18 in the field of view of the camera 10. Referring to FIG. 3B, the camera 10 and logo 14 are shown from a side perspective. Since the logos 12, 14, and 16 are oriented far from directly facing the camera 10, they appear distorted when they are displayed. In addition, since the logos 12, 14, 16 are often affixed to the curved roof 18 surface the distortion is often quite significant. In the depicted embodiment, the logos are positioned within about three feet from the lens of the camera.

A number of different factors cause the above-described distortion. Some of the distortion factors in play include (1) distortion due to the characteristics of the camera lens, (2) distortion due to the image placement relative to the camera, and (3) distortion due to the fact that the image is placed on a non-planar surface. The present disclosure provides a method and apparatus that corrects for such distortion. It is to be understood that the embodiments of the invention herein described are merely illustrative of the application of the broad principles of the invention. In particular, the invention has much broader applicability than in the auto-racing context and has much broader applicability than to correct for only the distortion factors identified above. In addition, it should be appreciated that the present disclosure can be used to correct distortions of more than just corporate logos adjacent video cameras. Therefore, it should also be appreciated that the term logo herein is used interchangeably with graphic, and can be any image that the user desires to view via a lens. It should also be appreciated that the term camera is used generically herein to refer to anything capable of capturing, recording, displaying, or projecting images.

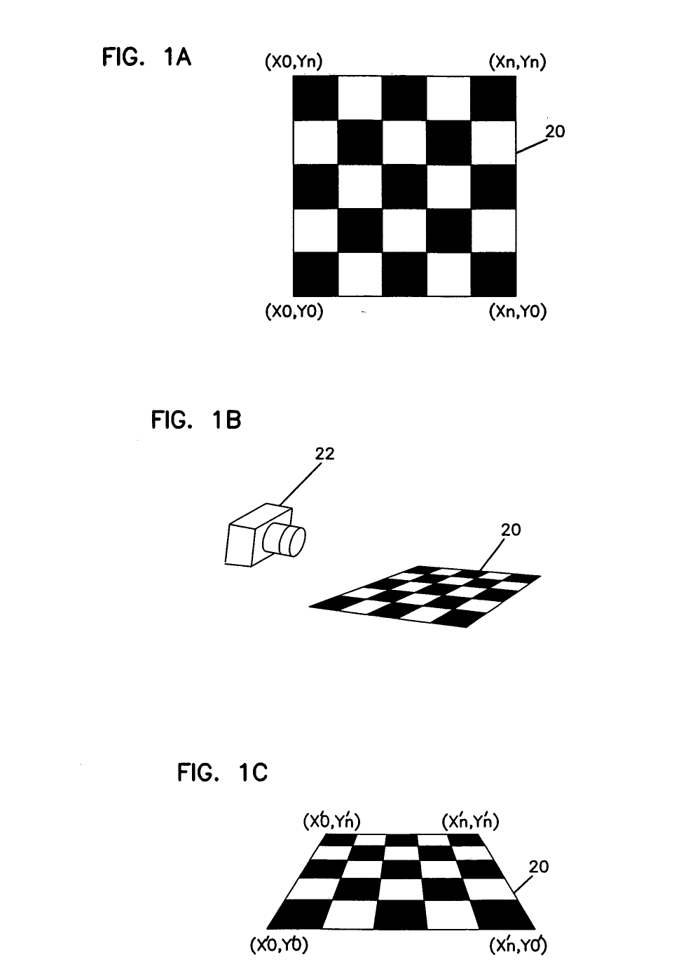

Referring to FIGS. 1A-C, the method of correcting for distortion is described herein. The process includes a mapping step, which involves creating a reference image 20. See FIG. 1A. The reference image 20 is used to estimate the expected distortion given a particular camera and image configuration and arrangement. The reference image 20 can take any number of forms.

In an embodiment, the reference image 20 is a high contrast grid layout that enables clear imaging when viewed through the camera 22. FIG. 1A shows the image including a square coordinate system, although numerous other reference images are also possible. The reference image 20 contains a number of points whose relative location is known. In a depicted embodiment, these reference points are located at the corners of each of the squares, and are labeled (Xn, Yn) where n is an integer.

Referring to FIG. 1B, the reference image is positioned at the desired location relative to the camera 22. The approximate appearance of the reference image 20 when viewed from the camera 22 is shown in FIG. 1C. The exact appearance of the reference image will depend on the lens distortion, the relative angle between each portion of the image 20 and the camera 22, and the contours of the surface to which the reference image is affixed.

The reference points as seen from the camera are labeled (X′n, Y′n) where n is an integer. The location of the reference points as seen by the camera is then measured relative to a chosen reference point within the reference image 20. For each of the original (X, Y) coordinates there is one (X′, Y′) coordinate. People of ordinary skilled in the art of 2-d mathematical transformation can create a piece-wise linear mapping between the (X′, Y′) called prime coordinates, and the (X,Y) called non-prime coordinates. The mathematical transformation functions are described in detail by Lyubomir Zagorchev & Ardeshir Goshtasby in their article titled, “A Comparative Study of Transformation Functions for Nonrigid Image Registration” published in IEEE Trans. Image Processing, vol. 15, no. 3, March 2006, pp. 529-538., which is incorporated herein by reference. This mapping creates a series of transformation functions that, when applied to the primed coordinates, will return the non-primed coordinates. In practice, this transformation will likely not be exact due to small errors in determining the location of the reference points as seen by the camera 22. These small errors will generally be acceptable and not significantly modify the final results. Once the transformation functions have been computed, these functions are then used to compute transformations for the coordinates of desired final images.

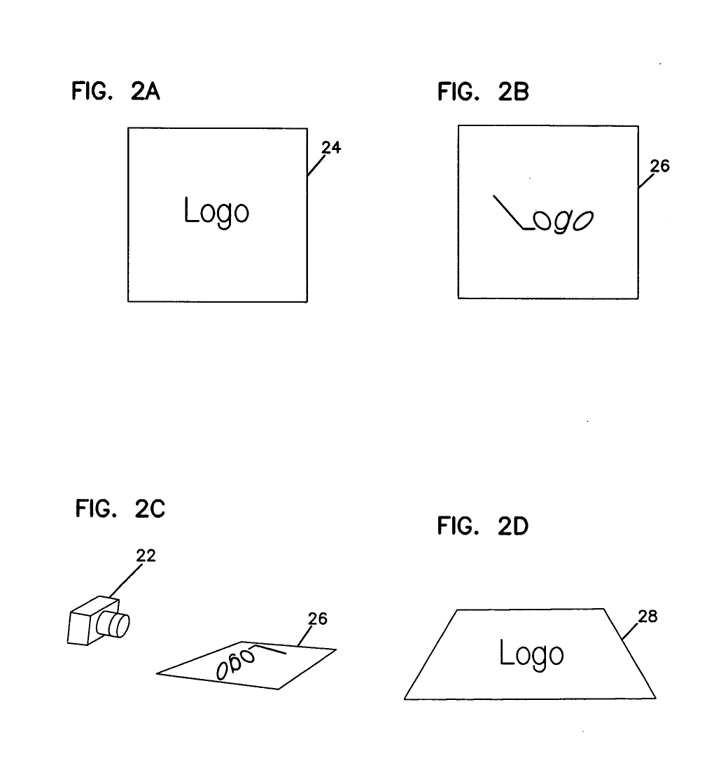

Referring to FIGS. 2A-D, the steps of correcting distortion based on a reference image 20 are described in further detail. FIG. 2A depicts the final desired image 24 to be displayed via the camera 22. The coordinates of the final image are individual pixels. The mapping for pixels that lie between reference coordinates of the reference image 20 is computed using interpolation, which is known in the art. The final image 26 (physical image) after transformation is shown in FIG. 2B. Referring to FIG. 2C, the final image 26 is then printed as a logo and affixed to the desired surface (also referred to herein as the target surface). The desired surface is typically the same surface the reference image was placed on during the mapping step. In an alternative embodiment, the desired surface could be a different, but similar, oriented surface relative to a camera 22.

When the final image 26 is viewed through the camera 22, the displayed logo 28 appears undistorted as shown in FIG. 2D. This displayed logo 28 is an actual image of the final image 26 that appears substantially identical to the final desired image 24. In the depicted embodiment, the relative proportions of the displayed logo 28 are correlated to the relative proportions of the desired image 24. It should be appreciated that in most embodiments, the proportions of the display logo 28 do not need to be mathematically exact as the goal is simply to present an otherwise distorted looking logo as less distorted and potentially even undistorted to the naked eye. By employing the above-described methods and techniques of the present invention, one can create images that correct for, at least, distortion caused by the lens characteristics, distortions due to the relative angle between the plane of the image and plane of the camera sensor, and distortion due to curvature of the surface on which the image is located.

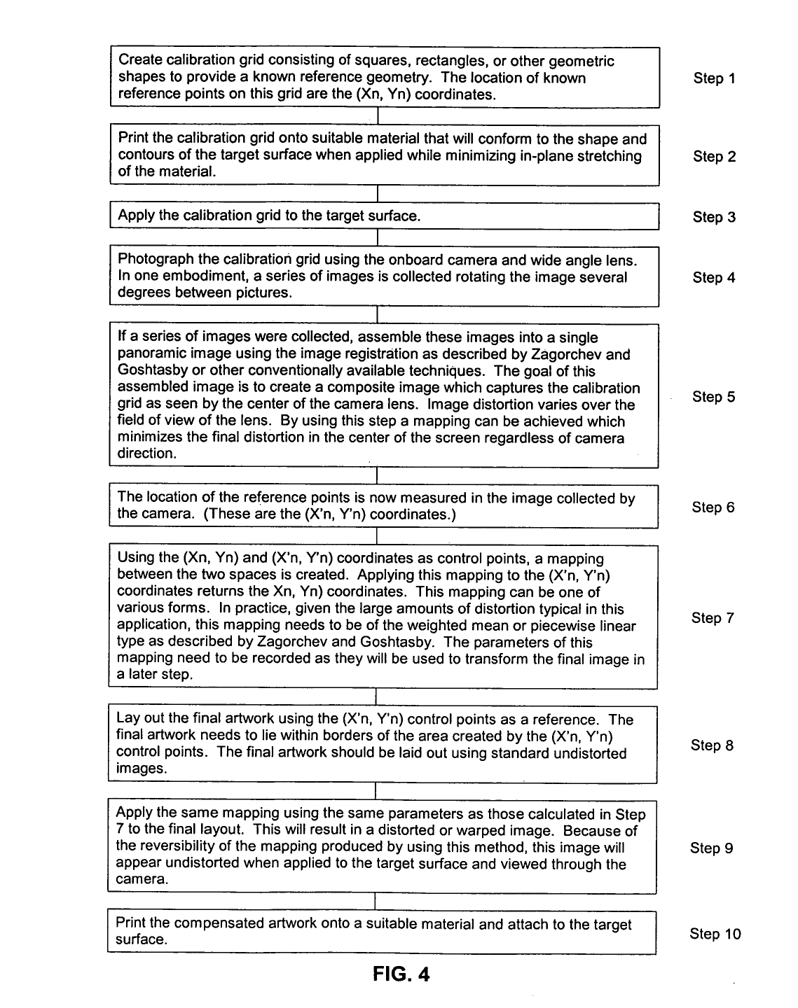

Referring to FIG. 4, a flow diagram describing a method according to an embodiment of the present invention is described. Most of the recited steps have been addressed in the above description. However, it should be noted that steps 4 and 5 describe the mapping step of a particular embodiment of the disclosure in greater detail. In particular, steps 4 and 5 involve the steps of image mapping wherein a composite image of the calibration grid is collected from a number of individual pictures taken from a varying camera angular position. Taking a number of pictures from various angles enables one to target the mapping to provide the best correction in the center of the display view regardless of camera angular position.

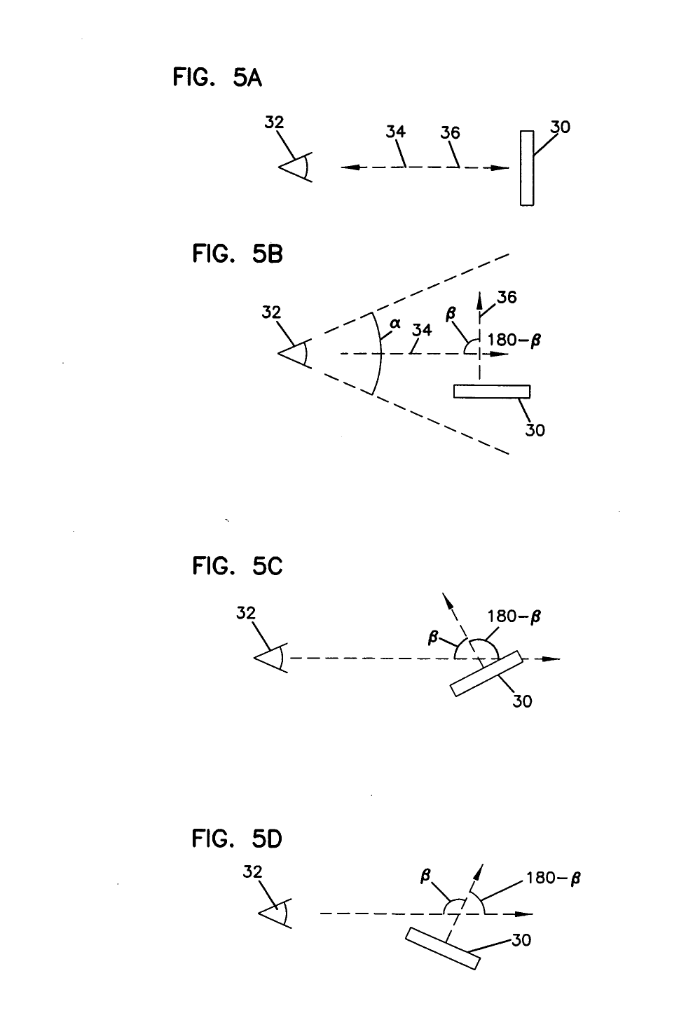

According to an embodiment of the present disclosure, the method and resulting apparatus can be used in an arrangement wherein the lens and image are skewed (misaligned). One measure for the amount that the lens and image are skewed is shown in FIGS. 5A-5D. It should be appreciated that the lens can be any lens at a fixed orientation relative to the image (for example, the lens can refer to the lens of a video camera, a camera for photographs, or even the lens of a human eye). Referring to FIG. 5A, the image 30 is aligned with a lens 32. Referring to FIG. 5B, the front surface of the image 30 is positioned perpendicular to the line of sight 34 of the lens. In particular, the dashed line 36, which is perpendicular to the surface of the image 30, intersects the dashed line 34, which is the line of sight of the lens. The angle to the left of the intersection is referenced as angle β and the angle to the right of the intersection is referenced as the angle 180-β. The angle β in FIG. 5B is 90 degrees. The line of sight of the lens is in the center of the field of view of the lens, which is referenced as α in FIG. 5B. In the case wherein the lens is the lens of a wide-angle camera, the angle α can be, for example, between 60 to 120 degrees.

Referring to FIG. 5C, the image 30 is inclined towards the lens 32. The angle β is less than 90 degrees. In the depicted embodiment, the angle β is about 60 degrees. Referring to FIG. 5D, the image 30 is inclined away from the lens 32. The angle β is greater than 90 degrees. In the depicted embodiment, the angle β is about 150 degrees. It should be appreciated that the image 30 can be curved, thereby having portions at different angles relative to the lens. In one embodiment of the present disclosure, the distortion correction method and associated apparatus (the physical image) is configured to be positioned at an angle relative to a lens, wherein the angle β is generally between 60 to 150 degrees. In one embodiment of the present disclosure, the apparatus is configured to be positioned at an angle relative to a lens, wherein the angle β is generally between 80 to 130 degrees. In another embodiment of the present disclosure, physical image is non-planer and portions of the physical image are at different angles relative to the lens, and wherein angle β ranges between about 60 to 150 degrees. In yet another embodiment of the present disclosure, physical image is curved away from the lens and portions of the physical image are at different angles relative to the lens, and wherein the angle β range increases as the distance from the lens increases. See, for example, FIG. 3B.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A printed image comprising:
a substrate having a front surface and a back surface, wherein the front surface includes an image,
wherein the image is distorted such that the image appears undistorted when viewed though a lens positioned at a known orientation relative to the image.

2. The printed image of claim 1, wherein the back surface of the substrate includes an adhesive material.

3. The printed image of claim 1, wherein the substrate is flexible and configured to conform to a contoured supporting surface.

4. The printed image of claim 1, wherein the back surface of the substrate includes a magnetic material.

5. The printed image of claim 1, further comprising a camera, wherein the camera is positioned such that an angle β between a lens of the camera and any portion of the front surface of the image is between 60-150 degrees.

6. The printed image of claim 5, wherein the camera is a video camera and wherein the lens of the camera has a field of view that is greater than 100 degrees.

7. The printed image of claim 1, further comprising a camera, wherein the camera is positioned such that an angle β between a lens of the camera and any portion of the front surface of the image is between 80-130 degrees.

8. The printed image of claim 7, wherein the camera is a video camera and wherein the lens of the camera has a field of view that is greater than 60 degrees.

9. The printed image of claim 1, wherein the back surface of the substrate is affixed to an exterior surface of a motor vehicle.

10. The printed image of claim 1, wherein the image is of a corporate logo with known proportions, and wherein the image is distorted such that the image appears to have the same known proportions when viewed through a lens positioned at a known orientation relative to the image.

11. The printed image of claim 1, wherein the shape of the substrate represents a corporate logo.

12. A method of advertising on a motor vehicle comprising:
connecting a camera to an outer surface of a motor vehicle, providing a distorted logo near the camera on the outer surface of the motor vehicle.

13. The method of claim 12, wherein the camera includes a lens having a field of view that is greater than 60 degrees.

14. The method of claim 12, wherein the logo is within 36 inches from the lens of the camera.

15. The method of claim 12, wherein the lens of the camera is positioned such that the angle β between the camera and any portion of the front surface the logo is between 80 to 130 degrees.

16. The method of claim 12, wherein the camera is configured to provide video of images that move relative to the camera in addition to a still image of the logo.

17. The method of claim 12, wherein the logo is distorted such that it appears undistorted when viewed through the camera.

18. A method of correcting for camera lens and camera orientation distortion comprising:
estimating the expected distortion of an image when viewed through a camera at a fixed orientation relative to an image;
generating a distorted image that compensates for the expected distortion, such that when the distorted image is viewed through the camera the distorted image appears undistorted;
printing the distorted image; and
positioning the distorted image at the fixed orientation.

19. The method of claim 18, wherein the step of estimating the expected distortion further comprises mapping the target location of the image.

20. The method of claim 19, wherein the step of identifying the expected distortion further comprises collecting a plurality of images with a calibration grid and assembling the images into a single image using image registration to create a composite image.
